(19) United States
(12) Patent Application Publication
(10) Pub. No.: US 2020/0175610 A1
(43) Pub. Date: Jun. 4, 2020

(54) COGNITIVE COLLABORATION

(71) Applicant: INTERNATIONAL BUSINESS MACHINES CORPORATION, Armonk, NY (US)

(72) Inventors: Anand Pikle, Pune (IN); Amol Dhondse, Kothrud (IN); Soumitra Limaye, Aundh (IN); Jignesh K. Karia, Thane (IN)

(21) Appl. No.: 16/208,151

(22) Filed: Dec. 3, 2018

(51) Int. Cl. G06Q 50/00; G06Q 50/14; G06Q 30/02; G06N 20/00

(52) U.S. Cl. CPC G06Q 50/01; G06N 20/00; G06Q 30/0201; G06Q 50/14

(57) ABSTRACT

Cognitive collaboration includes establishing a communications channel linking a computing node to a collaborative network over which multiple parties share data that includes one or more related features and one or more related parameters. Shared data can be retrieved from one or more other computing nodes communicatively linked to the collaborative network. Using a predictor model constructed using machine learning, a list of recommended items based on the shared data can be generated.

### BACKGROUND

The present disclosure is related to computer systems and networks, and more particularly, to cognitive systems and collaborative networks for travelers.

As the sophistication and scope of computer systems and networks has increased, so too, has the number of areas in which these technologies are applied. Travel is one example. Computer systems and networks have automated many tasks related to travel, from airline reservations to trip planning and more. One of the newer technological applications is with respect to travel bags and luggage. Conventional luggage has been made “smart” by adding features such as Wi-Fi hotspots, Bluetooth, SIM cards, GPS, and built-in batteries. Smart luggage thus provides a diverse array of applications beyond merely serving as a container in which travel items are carried.

### SUMMARY

A method of cognitive travel collaboration includes establishing a communication link to a collaborative network with a computing node, the collaborative network being one over which multiple parties share travel data. The method can include retrieving shared travel data from another computing node communicatively linked to the collaborative network. The method can also include generating a list of recommended travel items based on the shared travel data using a predictor model, the predictor model being constructed using machine learning.

A system includes a first computing node having at least one processor programmed to initiate executable operations. The executable operations include establishing, with the first computing node, a communication link to a collaborative network over which multiple parties share travel data comprising at least one travel-related feature and at least one travel-related parameter. The executable operations can include retrieving shared travel data from a second computing node communicatively linked to the collaborative network. Additionally, the executable operations can include generating, using a predictor model constructed using machine learning, a list of recommended travel items based on the shared travel data.

A computer-readable medium includes a computer readable storage medium having program code stored thereon, the program code being executable by the processor of a first computing node. The executable code can initiate operations that include establishing, with the first computing node, a communication link to a collaborative network over which multiple parties share travel data comprising at least one travel-related feature and at least one travel-related parameter. The operations also can include retrieving shared travel data from a second computing node communicatively linked to the collaborative network. Additionally, the operations can include generating, using a predictor model constructed using machine learning, a list of recommended travel items based on the shared travel data.

### BRIEF DESCRIPTION OF THE DRAWINGS

FIG. 1 depicts a cloud computing environment according to an embodiment of the present invention.

FIG. 2 depicts abstraction model layers according to an embodiment of the present invention.

FIG. 3 depicts a cloud computing node according to an embodiment of the present invention.

FIG. 4 depicts a computing environment in which a cognitive travel collaboration system is implemented according to an embodiment of the present invention.

FIG. 5 is a flow chart of a method of cognitive travel collaboration according to an embodiment of the present invention.

FIG. 6 is a flow chart of a method of cognitive travel collaboration according to an embodiment of the present invention.

### DETAILED DESCRIPTION

The present disclosure relates to cognitive systems and collaborative networks that facilitate travel planning, especially among fellow travelers planning a joint trip.

One common and often burdensome aspect of travel—whether for business or relaxation—is the need to pack every item the traveler will likely need, subject to the constraint that all the items must fit into the limited space available in the traveler's luggage. Other constraints depend on the mode of travel and include travel restrictions on the type and size of items that can be carried. Whether the challenge is made easier or more difficult for travelers undertaking a joint trip depends on how and to what extent the travelers can coordinate their planning and packing.

A system, described in various embodiments herein, predicts items that should be included in the traveler's luggage and recommends to the traveler that the items be packed. The system predicts the items based on a predictor model. The model is constructed using machine learning to “train” a set of parameters, or predictor variables, to map data pertaining to the traveler's planned trip to a list of items recommended be packed for the trip. The parameters are trained by iteratively changing the parameter's values to determine those values that generate a list that most satisfactorily matches the items that the traveler, in fact, desires to pack.

Accordingly, model accuracy is a function of both how many items that the traveler chooses to pack are correctly anticipated by the model, as well as how few items recommended are ones that the traveler does not wish to pack. The identities of items that were selected for packing by the traveler are stored as data in a memory and serve as part of a corpus of training data used by the system to automatically update model parameters.

The travel data used by the model to generate the list of recommended items encompasses a wide range of travel-specific “feature” values. Features can include, for example, the nature of the trip (e.g., is the purpose business or relaxation?), places that the traveler is likely to visit, and other variables based on data from similar previous trips. Contextual parameters can include items such as current weather forecasts, current travel restrictions, and factors the system recognizes as possibly affecting the traveler's plans and packing decisions. An important set of features the system considers pertain to the traveler's fellow travelers. Are they family? Business colleagues? The collaborative nature of the system allows the system to predict which items that the fellow travelers will need and which items they are likely to pack. The system coordinates the packing such that necessary items are not overlooked, other items are not unnecessarily duplicated, and potential conflicts are avoided.

The system, as described in detail below, creates a collaborative network through which fellow travelers share travel data. Through the collaborative network the traveler can access parameters, including contextual parameters, specifically associated with the type of travel the traveler is planning. The travel-specific parameters serve as input to the predictor model the system uses to map travel data to a list of items the system recommends to the traveler for packing. The items the traveler chooses to pack, likewise, can be broadcast to fellow travelers through the collaborative network.

Broadcasting the identities of items that each traveler chooses to pack serves at least two distinct purposes. First, it allows the system to coordinate packing among the fellow travelers (e.g., using a travel collaboration server, as described below). The system can, for example, identify items that none of the travelers have decided to pack, but which probably should be packed, such as medication for a family member. Conversely, the server can identify items that are needed, but only one member of the travel group need carry, such as an exhibit to be used by a group of business colleagues traveling to make a presentation. The system also can identify “conflicting” items, such as a clashing attire for a business trip that is expected to include a formal dinner engagement. The system can send alerts to each of the fellow travelers identifying items overlooked, conflictive, duplicative, or otherwise problematic to thereby facilitate travel collaboration.

A second purpose in broadcasting travel data is that travel data from multiple travelers traveling under similar circumstances can be collected by the system and either stored or added directly to the corpus of training data for updating the system-built predictor model. Leveraging data collected on similar trips by fellow travelers traveling under similar circumstances is an efficient mechanism for enlarging the training set, which can enhance the predictor model's accuracy. The system and methods of cognitive collaboration among travelers is described with greater detail below.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

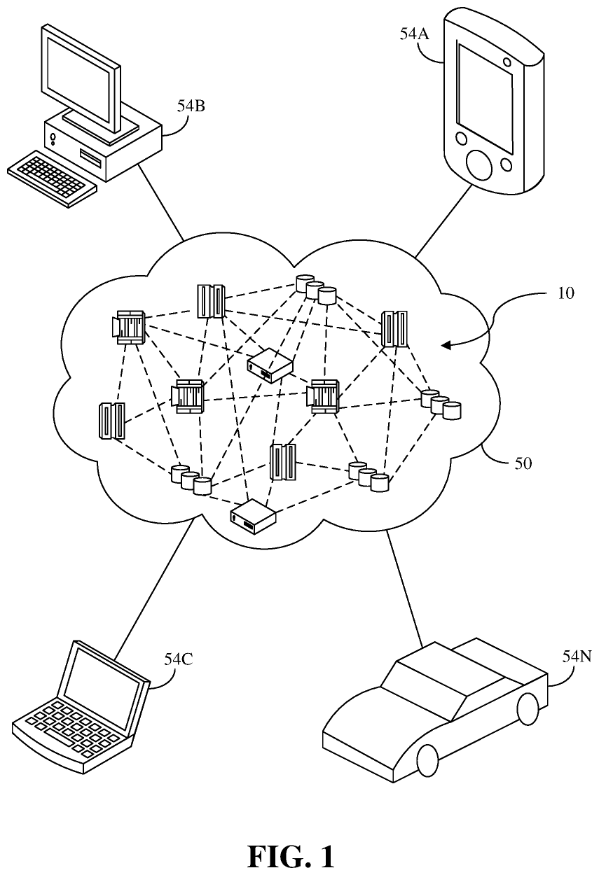

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

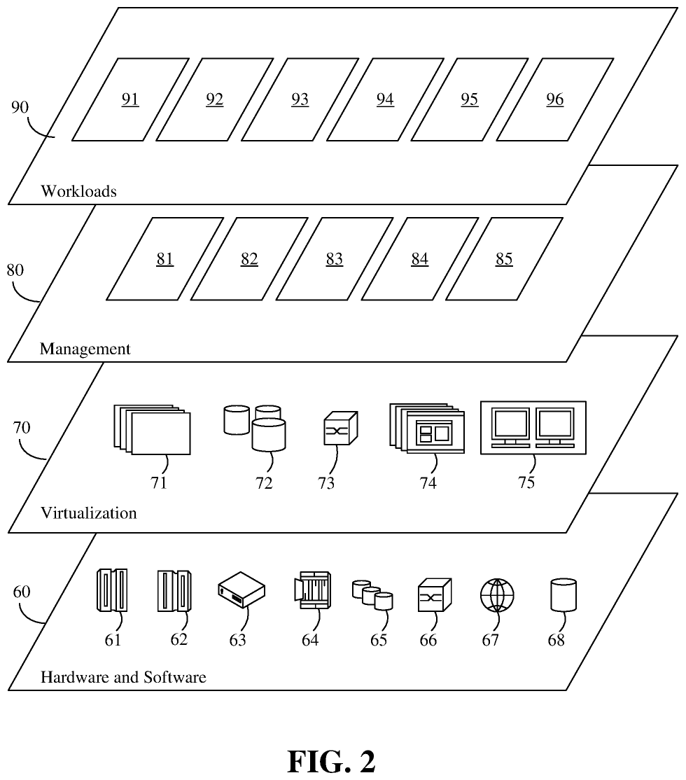

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA. Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and coordinating travel among multiple travelers using a cognitive travel collaboration system 96.

In one or more embodiments, cognitive collaboration system 96 includes a system-trained predictor model that maps travel-specific data comprising a set of feature values (e.g., nature of trip, destination, purpose, fellow travelers, and related attributes specific to the travel) to a list of items, which the system recommends to a traveler planning a trip. Items the traveler in fact packs, or indicates will be packed, can be identified using a camera or other sensing device. System 96 can include an object identifier trained using machine learning (e.g., visual deep learning) to recognize objects in visual data provided to the system. A list of the identified items can be broadcast to fellow travelers through a collaborative network. Likewise, through the collaborative network, the traveler can receive a list of items from one or more fellow travelers.

System 96 coordinates packing among the fellow travelers, including, for example, identifying items that none of the travelers have decided to pack, but which probably should be packed, as well as identifying duplicate items that only one traveler need carry for the whole group. An alert can be sent by system 96 indicating a packing adjustment is needed in such events. The travel data generated by system 96 relating to multiple travelers traveling under similar circumstances can be collected and used to update the system-trained predictor model.

In one embodiment, system 96 includes a travel collaboration server and one or more devices (“smart-luggage advisors”) capable of remotely accessing the travel collaboration server while remaining small enough to be incorporated in or unobtrusively coupled to luggage. The term smart-luggage as used herein includes conventional luggage which incorporate a smart-luggage advisor, or to which a smart-luggage advisor is connected. As described in greater detail below, in various embodiments, a smart-luggage advisor is configured to connect via a near-field communication channel (e.g., Wi-Fi) to a networked device such as a smartphone or network-connected laptop in order to communicate with the travel collaboration server. In a particular embodiment, the travel collaboration server is a cloud-based server and smart-luggage advisors are cloud-based computing nodes that connect to the server.

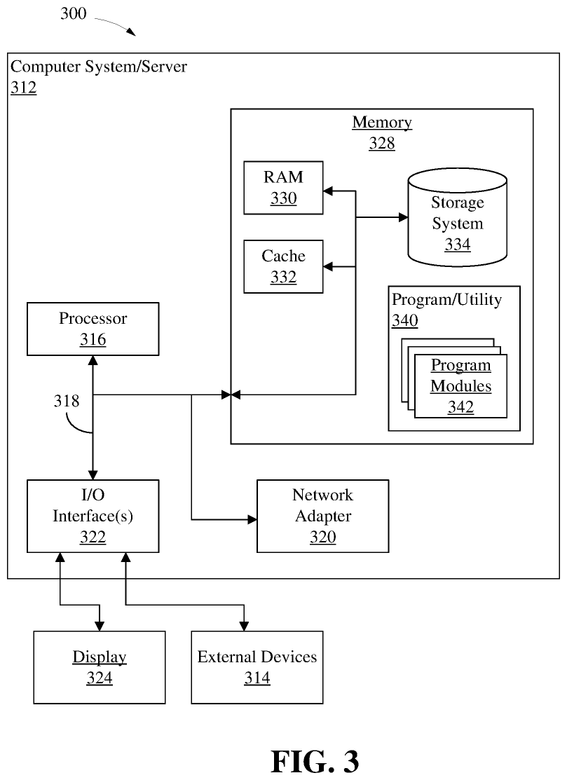

Referring now to FIG. 3, a schematic of an example of a cloud computing node is shown. Cloud computing node 300 is only one example of a suitable cloud computing node and is not intended to suggest any limitation as to the scope of use or functionality of embodiments of the invention described herein. Regardless, cloud computing node 300 is capable of being implemented and/or performing any of the functionality set forth hereinabove.

Cloud computing node 300 includes a computer 312, which is operational with numerous other general-purpose or special-purpose computing system environments or configurations. Examples of well-known computing systems, environments, and/or configurations that may be suitable for use with computer 312 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer 312 can be described in the general context of computer system-executable instructions, such as program modules, being executed by a computer system. Generally, program modules can include routines, programs, objects, components, logic, data structures, and other elements that perform specific tasks or implement particular abstract data types. Computer 312 can be practiced in distributed cloud computing environments where tasks are performed by remote processing devices that are linked through a communications network. In a distributed cloud computing environment, program modules can be located in both local and remote computer system storage media including memory storage devices.

As shown in FIG. 3, computer 312 in cloud computing node 300 is shown in the form of a general-purpose computing device. The components of computer 312 can include, but are not limited to, one or more processors 316, a memory 328, and a bus 318 that couples various system components including system memory 328 to processor 316.

Bus 318 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 312 typically includes a variety of computer system readable media. Such media can be any available media that is accessible by computer 312, and it includes both volatile and non-volatile media, removable and non-removable media.

Memory 328 can include computer system readable media in the form of volatile memory, such as random-access memory (RAM) 330 and/or cache memory 332. Computer 312 can further include other removable/non-removable, volatile/non-volatile computer system storage media. By way of example, storage system 334 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 318 by one or more data media interfaces. As will be further depicted and described below, memory 328 can include at least one program product having a set (e.g., at least one) of program modules that are configured to carry out the functions of embodiments of the invention.

Program/utility 340, having a set (at least one) of program modules 342, can be stored in memory 328 by way of example, and not limitation, as well as an operating system, one or more application programs, other program modules, and program data. Each of the operating system, one or more application programs, other program modules, and program data or some combination thereof, can include an implementation of a networking environment. Program modules 342 generally carry out the functions and/or methodologies of embodiments of the invention as described herein.

For example, one or more of the program modules can include cognitive travel collaboration system 96 or portions thereof. Program/utility 340 is executable by processing unit 316. Program/utility 340 and any data items used, generated, and/or operated upon by node 300 are functional data structures that impart functionality when employed by node 300. As defined within this disclosure, a “data structure” is a physical implementation of a data model's organization of data within a physical memory. As such, a data structure is formed of specific electrical or magnetic structural elements in a memory. A data structure imposes physical organization on the data stored in the memory as used by an application program executed using a processor.

Computer 312 can also communicate with one or more external devices 314 such as a keyboard, a pointing device, a display 324, etc.; one or more devices that enable a user to interact with computer 312; and/or any devices (e.g., network card, modem, etc.) that enable computer 312 to communicate with one or more other computing devices. Such communication can occur via Input/Output (I/O) interfaces 322. Computer 312 can communicate with one or more networks such as a local area network (LAN), a general wide area network (WAN), and/or a public network (e.g., the Internet) via network adapter 320. As depicted, network adapter 320 communicates with the other components of computer 312 via bus 318. It is noted that, although not shown, other hardware and/or software components could be used in conjunction with computer 312. Examples include, but are not limited to: microcode, device drivers, redundant processing units, external disk drive arrays, RAID systems, tape drives, and data archival storage systems, etc.

While node 300 is used to illustrate an example of a cloud computing node, it should be appreciated that a computer system using an architecture the same as or similar to that shown in FIG. 3 can be used in a non-cloud computing implementation to perform the various operations described herein. In this regard, the example embodiments described herein are not intended to be limited to a cloud computing environment.

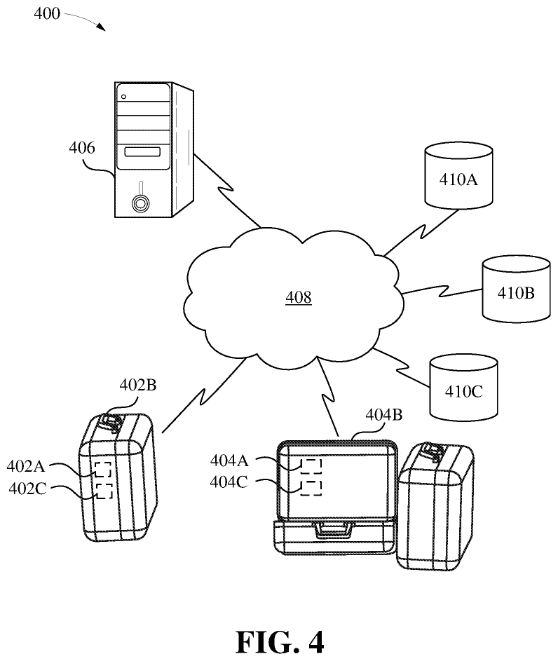

FIG. 4 depicts a distributed computing environment 400 in which, according to one embodiment, cognitive travel collaboration system 96 can be implemented. Illustratively, system 96 is implemented in three computing nodes 402A, 404A, and 406. As described herein, computing node 406 serves as a travel collaboration server. Computing nodes 402A and 404A exchange data with the travel collaboration server, computing node 406, over a collaborative network 408. Collaborative network 408, though shown as comprising three communicatively coupled nodes, can comprise any number of computing nodes and can be supported on any type of computer network infrastructure such as a LAN, WAN, or the Internet.

In one embodiment, computing nodes 402A and 404A are configured as smart-luggage advisors, that is, as devices that physically couple to or are incorporated within carry containers, which illustratively comprise pieces of luggage 402B and 404B. Carry containers can be any type of bag or luggage used for travel. Thus, computing nodes 402A and 404A, whether configured as separate add-on devices or as embedded devices, can be sized so as to unobtrusively connect to or be incorporated in any type of luggage.

In one embodiment, each computing node 402A and 404A includes a sensing device 402C and 404C, respectively. Sensing device 402C or 404C can be, for example, a camera trained using machine learning (e.g., visual deep learning) to recognize objects. In another embodiment, sensing device 402C or 404C can be an RFID reader that senses object-affixed labels. In still another embodiment, sensing device 402C or 404C can be a voice communicator that, using natural language processing, recognizes speech for identifying objects. Through sensing devices 402C and 404C, computing nodes 402A and 404A identify objects (visually or by spoken word) that have been selected for travel. For example, sensing devices 402C and 404C can capture images as the objects are being placed in the luggage or a traveler can identify by voice which items have been or are intended to be placed in the luggage.

Computing nodes 402A and 404A, in one embodiment, are configured to exchange data with the travel collaboration server (node 406) through a near-field wireless communication link (e.g., Wi-Fi channel) to a networked device (not shown), such as a smartphone or stationary hotspot. Alternatively, or additionally, computing nodes 402A and 404A can be configured to communicate through a wired connection (e.g., Ethernet connector) to a networked device, such as a network-connected laptop computer. Computing nodes 402A and 404A can likewise communicate through a near-field wireless link or wired connection to a device such as a smartphone or laptop computer that has a camera or voice capability and that can operate as sensing devices 402C and 404C.

The travel collaboration server (node 406) can receive and service (e.g., sync push/pull) data requests from computing nodes 402A and 404A, as well as retrieve data from multiple data sources 410A, 410B, 410C that are accessible over a computer network (although three sources are shown, data can be retrieved by computing node 406 from any number of network sources). Data sources 410A, 410B, 410C can include for example travel booking systems, personal and corporate calendars, travel destination advisory APIs, and transport mode (e.g., airline, railway) status APIs. Other data sources include social collaboration platforms, local traffic APIs, and weather APIs.

System 96 includes a predictor model for recommending items that a traveler should pack, the prediction based on travel data submitted to the system by a traveler planning a trip, along with data captured from sources on social collaboration and other platforms. The predictor model can comprise a set of processor-executable instructions that execute on a processor such as processor 316. The instructions can be stored in a memory such as memory 328.

The predictor model is constructed by system 96 using machine learning (e.g., convolutional deep learning) to train a set of parameters, or predictor variables, for mapping traveler-submitted travel data and data captured from peripheral sources (e.g., social networking data) to a list of recommended items. The traveler-submitted data can comprise a feature vector, or n-tuple, whose values correspond to features such as the trip destination, time and duration of the trip, trip itinerary, and purpose of the trip. The parameters can comprise a weight vector, or n-tuple, whose values apply to corresponding elements of the features vector (e.g., dot, or inner, product of the two vectors), which jointly serve as inputs to a predefined function that yields classification values indicating a set of items to recommend to the traveler. The parameters can be trained by iteratively changing the parameter's values to determine those values that generate a list that most satisfactorily matches the items that the traveler, in fact, desires to pack. Training is done on a corpus of training data collected from prior trips and comprising correctly labeled feature vectors. Successive predictions are made based on the feature vectors and the predicted results are compared to the labels to determine whether the prediction matches the label. Contextual parameters are updated until a set of parameters is determined which yield satisfactory percentage (model accuracy) of matches. A measure of accuracy is the number of items that the model predicts/recommends and that the traveler in fact chooses to pack and the number predicted/recommended by the model that the traveler chooses not to pack.

System 96, in one embodiment, can permit a traveler to select specific items to include as features for input to a predictor model constructed by the system. The selected features can be extracted by system 96 from various data collected by the system and used by the system to build a specific version of the predictor model applicable to specific circumstances. For example, a traveler might select business attire as a feature in building a predictor model version to be used for recommending items for a business trip. Weather might not be important if the trip must be made regardless of weather conditions, but weather could be important to a traveler planning a vacation or considering travel during a holiday season. In the latter case, the version of the predictor model generated by system 96 would be different than one applicable to business travel by the user. As another example, trip itinerary can be feature. If the itinerary includes attending a local outdoor festival during a forecasted cold snap, then, if weather is a considered feature, the system can generate a list that includes warm, outdoor attire.

Using system 96, a traveler can transmit travel data via computing node 402A to the travel collaboration server (node 406) regarding an upcoming trip. The travel data can indicate the different features the system uses in generating a list of items that the system recommends to the traveler. Features include, for example, trip destination, time and duration of the trip, trip itinerary, and the trip purpose (e.g., a specific business purpose, such as attend conference or make sales presentation).

Operatively, cognitive collaboration can be triggered in system 96 by a traveler connecting to the travel collaboration server (node 406). System 96, based on the travel data submitted by the traveler, pulls parameters (e.g., weight vector) and contextual information from the travel collaboration server (node 406). The travel data (e.g., feature vector) is used by system 96 as input to the predictor model function to determine the list of items to recommend the traveler pack. System 96 can optionally retrieve trip-relevant data from the various data sources 410A, 410B, 410C for input to the predictor model. The data culled from these sources can include, for example, items from a corporate calendar for a traveler traveling on business on behalf of a corporation. In the event the calendar indicates, for example, that a formal reception is scheduled, the system can include formal attire among the list of items to be packed. In another scenario, system 96 can retrieve data from a social collaboration platform, the data perhaps indicating that during a planned business trip colleagues will continue working on a project related to a construction site, thus prompting the system to recommend the traveler pack a pair of heavy-soled shoes. Or the retrieved data might indicate that friends with whom the traveler is taking an excursion abroad plan to perform at an amateur chamber music festival, prompting the system to recommend that the traveler include her cello among the luggage.

Items that the traveler ultimately decides to pack, or indicates will be packed, are captured as images or recorded as voice expressions by sensing device 402C and conveyed to computing node 402A. The identities of items that were selected for packing by the traveler can be stored as data in a memory and serve as part of a corpus of training data that system 96 uses for updating predictor models on an on-going basis to thereby improve accuracy and adapt the models to new travel circumstances and conditions. The items identified by sensing device 402C can be conveyed by computing node 402A to the travel collaboration server (node 406) and shared via collaborative network 408 with a traveler using computing node 404A. Likewise, items the traveler using computing node 404A packs, or intends to pack, are identified by sensing device 404C and conveyed to the travel collaboration server. Identified items can be broadcast to all fellow travelers connected to system 96, the system using the collected data to facilitate collaboration among the travelers.

Using the collected data, system 96 coordinates packing among fellow travelers. The travel collaboration server (node 406) can, for example, identify items that none of the travelers have decided to pack, but which probably should be packed, such as medication for a member of a family going on vacation. Conversely, the server can identify items that are needed, but that only one traveler in the travel group need carry. For example, a group of colleagues may be traveling to make a presentation that requires a particular exhibit, which only one of the travelers need carry. System 96 can identify the exhibit, based on supplied travel data, and alert the travelers if the system determines that no one has packed or indicated an intent to pack the exhibit. Conversely, if only one exhibit is needed, but multiple travelers are planning to carry a copy, system 96 can alert the travelers of the unnecessary duplication. The system also can identify “conflicting” items. For example, if travel data submitted to system 96 by the travelers indicates the itinerary includes attendance at a formal event, the system can send an alert if two of the travelers pack or intend to pack formal dresses in the same color and style.

Travel data collected by system 96 from multiple travelers traveling under similar circumstances can be stored in memory (e.g., on the travel collaboration server) or added directly to the corpus of training data for updating the system-built predictor model. Leveraging data collected on similar trips by fellow travelers traveling under similar circumstances is an efficient mechanism for enlarging the training set, which enhances the predictor model's accuracy, as well as facilitates travel collaboration.

The operative features of system 96 have been described in terms of smart-luggage advisors that communicate with the travel collaboration server. In different embodiments, however, system 96 can additionally, or alternatively, be implemented in processor-executable code that executes on the processor of a handheld device such as a smartphone, a networked computer such as a laptop, or a similar device. Thus the computing nodes can be for example a smartphone, networked laptop, or similar such device having one or more processors for executing code that implements system 96. System 96 comprising code running on such a device can be designed to utilize the image and/or voice capabilities of the device to capture an image or voice expression identifying items a traveler has packed or indicates an intent to pack. Likewise, system 96 can be designed to utilize the wireless or wired communications hardware of the device to communicatively link with the travel collaboration server. In still another embodiment, the devices implementing system 96 can communicate over a peer-to-peer network, processing and exchanging data without the assistance of centralized server.

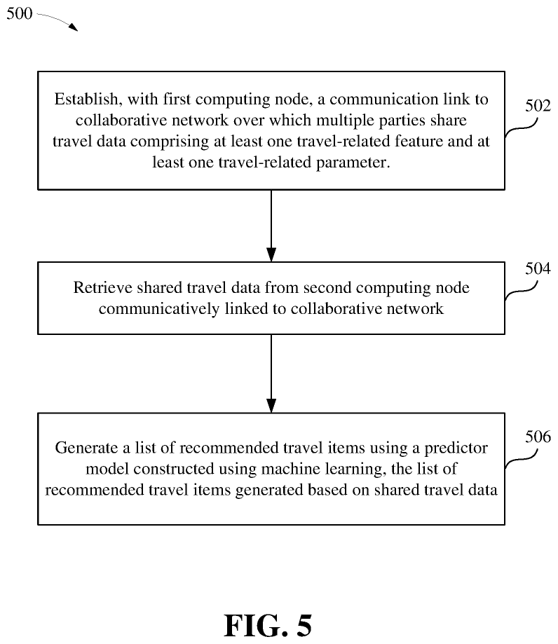

FIG. 5 is a flowchart depicting a method 500 for providing cognitive travel collaboration according to one embodiment. Method 500 can be performed by a system the same or similar to the systems described in connection with FIGS. 1-4. Method 500 can begin with a traveler accessing a computing node (defining a first computing node), which triggers the system to begin providing cognitive travel collaboration. At 502, the first computing node establishes a communication link to a collaborative network. The collaborative network is a network over which multiple parties share travel data, the data comprising at least one travel-related feature and at least one travel-related parameter. Shared travel data is retrieved by the system, at 504, from a second computing node that is communicatively liked to the collaborative network. At 506, the system generates a list of recommended travel items, generated based on the shared travel data using a predictor model. The list of recommended travel items can be provided by the system to a traveler at the first computing node.

The travel-related features can include the purpose of a trip (e.g., business or relaxation), trip destination, and/or trip itinerary (e.g., events to attend at specific locations at specific dates and time), as well as any other travel-related information that can be used as input (e.g., in the form of a feature vector) to the predictor model. The predictor model can apply stored parameter values (e.g., in the form of a weight vector) to the travel-related features to generate an input into a predictor model function. The predictor model function yields results (e.g., classification or categorization values) for predicting the travel items that the system recommends that a traveler take on the trip. Other travel-related data includes contextual parameters, such as weather predictions, travel bookings, travel or destination advisories, social collaboration data, and any other trip-specific data that could influence which items a traveler likely needs or, unless the traveler forgets, would want to pack. The data can be culled from various sites the system accesses over a computer network.

The system can identify one or more travel items that a traveler in fact packs or that the traveler indicates, in some manner, an intention to pack. The system can connect with the computing node to a sensing device, such as a camera or voice recognizer on a separate device (e.g., a smartphone or laptop computer) in a vicinity of the computing node such that the computing node can communicate with the device over a near-field (e.g., Wi-Fi) wireless channel or a wireline (e.g., Ethernet) connection. The system can use machine learning (e.g., deep learning) to construct a recognizer (e.g., executable code on a processor of the computing node) that identifies objects from the images of objects generated by a camera or words spoken into a voice-enabled device. The objects can be identified from captured images, spoken words, characters entered with a keypad, or other form that the recognizer is adapted to recognize as corresponding to specific objects.

The system can receive and re-broadcast lists of travel-designated items, receiving lists from and broadcasting lists to multiple computing nodes communicatively linked to the collaborative network. A computing node can communicate through a networked device, such as a smartphone or network-connected laptop computer, located relative to the node such that the node can link with the device over a near-field (e.g., Wi-Fi) wireless channel or a wireline (e.g., Ethernet) connection.

The system can update the recommended items list based on a comparison of the list with a different list of travel items received from at least one other computer node communicatively linked to the collaborative network and used by fellow travelers packing for a joint trip. Updates of lists of recommended travel items based on such comparisons can be broadcast by the system to fellow travelers at various computing nodes linked to the collaborative network.

The system can compare the recommended items lists of different members of a group travelling together (the fellow travelers) and identify items that none of the travelers have decided to pack, but which probably should be packed by at least one group member. For example, travel data can indicate that a family is planning to take a vacation, and the system, based on collected travel data, can recognize that a needed medication is not yet packed. The system can alert the travelers that they have overlooked an important travel item. Conversely, the system can identify items that are needed, but that only one group member needs to carry. For example, travel data can indicate to the system that colleagues traveling to make a joint presentation need to take an important exhibit. If only one specimen of the exhibit is needed, and the system recognizes that more than one of the colleagues is taking the exhibit, the system can alert the colleagues of the unnecessary inclusion of a duplicate copy. The system also can identify “conflicting” items. For example, travel data can indicate that fellow travelers plan to attend a formal reception at the group's travel destination. If the system recognizes that two of the travelers each plan to pack an identical gown unbeknownst to the other, the system can alert the travelers to the potential conflict.

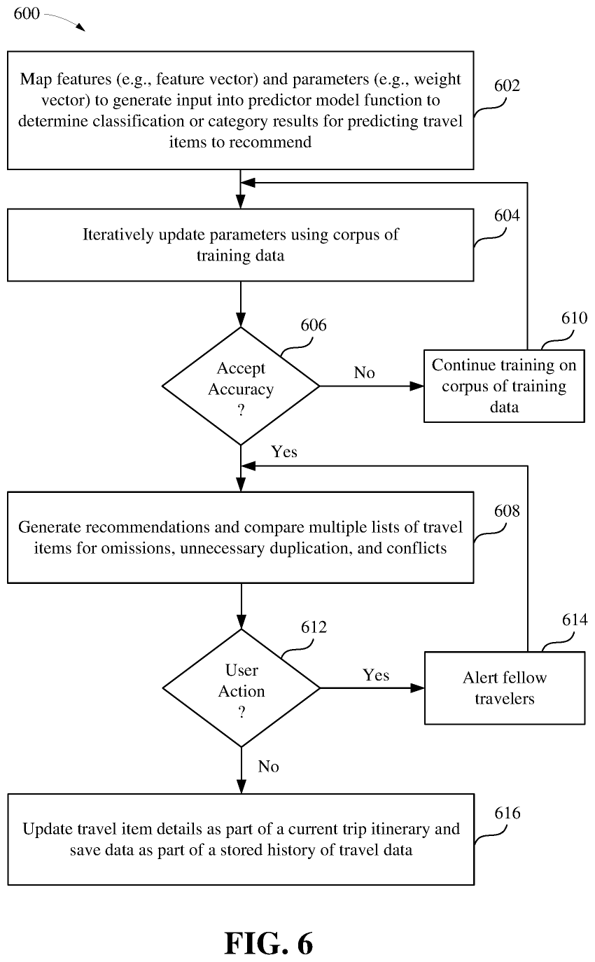

FIG. 6 is a flow chart depicting a method 600 for providing cognitive travel collaboration according to another embodiment. Method 600 can be performed by a system the same or similar to the systems described in connection with FIGS. 1-4. Method 600 can begin by the system collecting travel data. At 602, the system extracts and arranges travel data into features to use as inputs for predicting travel items to recommend to a traveler. The system at 604 “trains” parameters of a predictor model using a corpus of training data from previous travel. The accuracy of the model is assessed by the system at 606. If model accuracy is acceptable, the model is used at 608 to respond to new travel data as the system generates recommendations to travelers undertaking a joint trip the recommendations specifying items for the travelers to pack. Otherwise, at 610, the system continues to train the predictor model using the corpus of training data. Training can incorporate structure mapping engine (SME) feedback and include adding or removing items from the corpus of training data by a user.

The system, at 608, generates recommendations and compares multiple lists of travel items among a group of fellow travelers. Based on the comparisons, the system determines whether certain items that at least one traveler likely needs to pack have been overlooked. The system also identifies unnecessary duplication of items that the group is packing. Likewise, if any items designated for packing conflict, the system detects the conflict. If any of these events occur, the system determines at 612 whether the travelers need to take action and notifies each of the necessary action at 614. The system continues to alert travelers until all issues detected by the system are resolved. If at 612 the system determines that there are no problems, the system updates the travel item details and commits the data to a history of travel data stored in a system memory at 616.

The present invention can be a system, a method, and/or a computer program product at any possible technical detail level of integration. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIGS. 1-4 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

That which is claimed is:

1. A method, comprising
establishing, with a first computing node, a communication link to a collaborative network over which multiple parties share travel data comprising at least one travel-related feature and at least one travel-related parameter;
retrieving shared travel data from a second computing node communicatively linked to the collaborative network; and
generating, using a predictor model constructed using machine learning, a list of recommended travel items based on the shared travel data.

2. The method of claim 1, further comprising:
identifying, using a sensing device communicatively coupled to the first computing node, at least one selected travel item selected by a user for inclusion in a carry container;
generating a list of selected travel items; and
broadcasting the list of selected travel items to at least one other computing node communicatively linked to the collaborative network.

3. The method of claim 2, further comprising using machine learning to construct a recognizer model for identifying the least one selected travel item.

4. The method of claim 2, further comprising receiving a different list of travel items from at least one other computer node communicatively linked to the collaborative network and updating the list of recommended travel items based on a comparison of the list of selected travel items and the different list.

5. The method of claim 1, further comprising updating the predictor model based on a comparison of the list of recommended travel items and a different list of travel items received from at least one other computing node communicatively linked to the collaborative network.

6. The method of claim 1, further comprising updating the predictor model in response to user-supplied input.

7. The method of claim 6, wherein the user-supplied input comprises a list of selected travel items.

8. A system, comprising
a first computing node having at least one processor programmed to initiate executable operations, the executable operations including:
establishing, with the first computing node, a communication link to a collaborative network over which multiple parties share travel data comprising at least one travel-related feature and at least one travel-related parameter;
retrieving shared travel data from a second computing node communicatively linked to the collaborative network; and
generating, using a predictor model constructed using machine learning, a list of recommended travel items based on the shared travel data.

9. The system of claim 8, wherein the executable operations further include:
identifying, using a sensing device communicatively coupled to the first computing node, at least one selected travel item selected by a system user for inclusion in a carry container;
generating a list of selected travel items; and
broadcasting the list of selected travel items to at least one other computing node communicatively linked to the collaborative network.

10. The system of claim 9, wherein the executable operations further include using machine learning to construct a recognizer model for identifying the least one selected travel item.

11. The system of claim 9, wherein the executable operations further include receiving a different list of travel items from at least one other computer node communicatively linked to the collaborative network and updating the list of recommended travel items based on a comparison of the list of selected items and the different list.

12. The system of claim 8, wherein the executable operations further include updating the predictor model in response to user-supplied input.

13. The system of claim 12, wherein the user-supplied input comprises a list of selected travel items.

14. A computer program product, comprising:
a computer readable storage medium having program code stored thereon, wherein the program code is executable by a processor of a first computing node, and wherein the executable code can initiate operations that include:
establishing, with the first computing node, a communication link to a collaborative network over which multiple parties share travel data comprising at least one travel-related feature and at least one travel-related parameter;
retrieving shared travel data from a second computing node communicatively linked to the collaborative network; and
generating, using a predictor model constructed using machine learning, a list of recommended travel items based on the shared travel data.

15. The computer program product of claim 14, wherein the operations further include:
identifying, using a sensing device communicatively coupled to the first computing node, at least one selected travel item selected by a user for inclusion in a carry container;
generating a list of selected travel items; and
broadcasting the list of selected travel items to at least one other computing node communicatively linked to the collaborative network.

16. The computer program product of claim 15, wherein the operations further include using machine learning to construct a recognizer model for identifying the least one selected travel item.

17. The computer program product of claim 15, wherein the operations further include receiving a different list of travel items from at least one other computer node communicatively linked to the collaborative network and updating the list of recommended travel items based on a comparison of the list of selected items and the different list.

18. The computer program product of claim 14, wherein the operations further include updating the predictor model based on a comparison of the list of recommended travel items and a different list of travel items received from at least one other computing node communicatively linked to the collaborative network.

19. The system of claim 18, wherein the operations further include updating the predictor model in response to user-supplied input.

20. The computer program product of claim 18, wherein the user-supplied input comprises a list of selected travel items.
